(19) United States
(12) Patent Application Publication
(10) Pub. No.: US 2010/0185456 A1
(43) Pub. Date: Jul. 22, 2010

(54) MEDICATION MANAGEMENT SYSTEM

(75) Inventor: Aman Kansal, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/196,502

(22) Filed: Aug. 22, 2008

(51) Int. Cl. G06Q 50/00

(52) U.S. Cl. 705/2

(57) ABSTRACT

A system that monitors and tracks compliance to a medication regimen or schedule is provided. The system can measure and track dosage amounts together with the time in which tablets, pills or liquid are removed from a container. The information can be stored for compliance analysis. Additionally, the system can alter a user of a dosage schedule thereby enhancing compliance.

### BACKGROUND

Patients sometimes forget to take, or if/when they had taken, their medication as prescribed by a healthcare professional or manufacturer (e.g., over-the-counter medications). For instance a prescription may require a patient to take two tablets, three times a day. Suppose the patient was scheduled to take two tablets at 9:00 am. Next, suppose it is 10:00 am and the patient is unable to recall whether he took the mediation or not at 9:00 am. The best case scenario is that the patient took the medication at 9:00 am and does not ingest an additional dose. However, unfortunately, many times, patients will take another dose at 10:00 am thereby potentially overdosing. Alternatively, oftentimes, the patient forgot to take the 9:00 am dose and, if not sure if they took it or not, forgoes taking a dose at 10:00 am. Thus, compliance to the prescribed medicinal regimen is not adhered to and patient progress (or wellness) is affected negatively.

Today, adherence to prescribed medication is prevalent in the management of disease and therefore one leading factor of healing and prolonged wellness. Lack of adherence to dosage and prescription information can be due to a number of factors including forgetfulness, mistake, misunderstanding as well as intentional lack of adherence. Studies have shown that nearly half of those prescribed medication adhere to their various regimens.

Today, ongoing significant research is dedicated to monitoring and attempting to improve medication adherence, for example, for the elderly. In addition to independent studies and research, the FDA (Federal Drug Administration) is encouraging adherence monitoring for drug trials. As compared to manual monitoring methods, electronic event monitoring has been proven to correlate most with clinical outcomes and is presently considered the gold standard. Unfortunately, today, there are no effective mechanisms for removing human input into the event monitoring processes. Rather, conventional electronic tracking schemes employ a human action component for tracking in addition to electronic storage of tracked information. Thus, conventional event monitoring mechanisms are plagued with human error similar to manual recording techniques.

In addition to incorporating human error, traditional medication monitoring products are very cumbersome to use which essentially contributes to non-adherence. Additionally, today, electronic monitors are extremely costly thereby making their use impractical for many users. Furthermore, conventional approaches of electronic tracking of medication are not reusable between patients.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that monitors and tracks adherence to a medication regimen or schedule. The system can measure and track dosage amounts together with the time in which tablets or pills are removed from a bottle. In another aspect, liquid (and other forms of medication, e.g., powder, cream, patches) can be tracked. This monitored information can be used to establish a compliance measurement with regard to a prescribed regimen.

In yet other aspects of the system, mechanisms are provided that communicate the information from the bottle to the patient or other agencies using one or more communication channels (e.g., wired or wireless). Moreover, the system can provide a procedure to add supplementary service information, including revenue generating information such as advertisements, product orders, etc., to messages generated for users and other agencies based on information provided by the medicine bottle or container components.

Still other aspects of the system provide mechanisms to prolong the battery (or power cell) life or otherwise reduce the energy usage by the medicine bottle. For instance, embodiments employ solar cells, sleep modes, kinetic energy mechanisms, energy harvesting techniques, etc. Moreover, the system can employ components that are capable of determining which patient took the medicine, for example, in case of multiple patients using the same bottle. This can be useful for over-the-counter drugs used by a family or the like.

In yet another aspect thereof, a machine learning and reasoning (MLR) component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a system that manages medication regimen compliance in accordance with an aspect of the innovation.

FIG. 2 illustrates an example flow chart of procedures that facilitate tracking compliance in accordance with an aspect of the innovation.

FIG. 3 illustrates an example flow chart of procedures that facilitate compliance notifications in accordance with an aspect of the innovation.

FIG. 4 illustrates an example system that employs a sensing subsystem and analysis component to manage medication regimen compliance.

FIG. 5 illustrates an example block diagram of an analysis component in accordance with an aspect of the innovation.

FIG. 6 illustrates an example block diagram of a communication component in accordance with an aspect of the innovation.

FIG. 7 illustrates an example block diagram of a system that facilitates incorporation of supplementary information into a notification, report, alert, etc. in accordance with aspects of the innovation.

FIG. 8 illustrates an example block diagram of a system capable of counting medication units (e.g., tablets) in accordance with an aspect of the innovation.

FIG. 9 illustrates an example block diagram of a system that incorporates a counting subsystem into a medicine container lid.

FIG. 10 illustrates an example block diagram of a system that incorporates a weight subsystem into a medicine container.

FIG. 11 illustrates an example block diagram of a system that facilitates dosage recordation and prescription compliance in accordance with aspects.

FIG. 12 illustrates an example communication and annunciation module in accordance with aspects of the innovation.

FIG. 13 illustrates an example system that facilitates adding supplementary information in accordance with an aspect of the innovation.

FIG. 14 illustrates a block diagram of a computer operable to execute the disclosed architecture.

FIG. 15 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Additionally, a “component” and “system,” as used herein, can refer to a stand-alone mechanical entity or device as well a mechanical entity coupled to a software or computer-related entity. These examples will become evident upon a review of the figures and discussion that follows.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

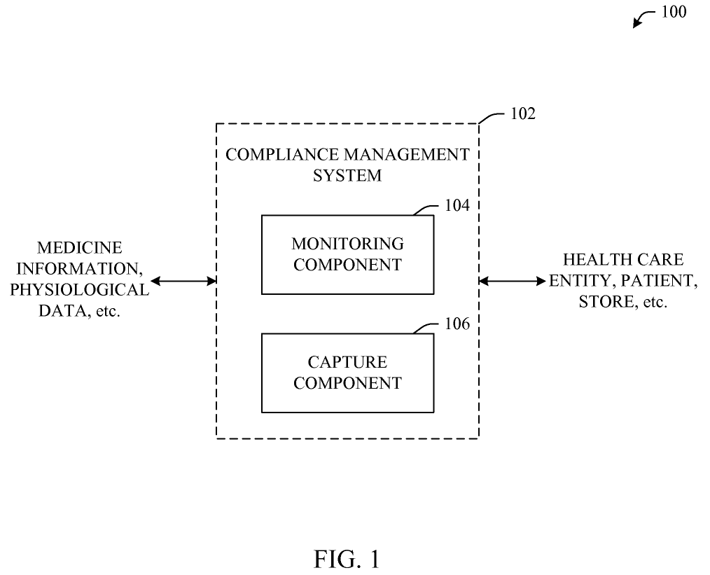

Referring initially to the drawings, FIG. 1 illustrates an example block diagram of a system 100 that facilitates tracking compliance with a medication regimen. In aspects, the regimen can be prescribed by a healthcare entity or professional, for example, a prescription to ingest a certain drug at a prescribed frequency and dosage. In other aspects, the regimen can be directed by a pharmacist or drug manufacturer, for example, for over-the-counter medications. It is to be appreciated that the source of the regimen can vary, thus, alternative aspects and examples different from those described herein can exist. These alternative aspects are to be included within the scope of this disclosure and claims appended hereto.

The innovation described herein can essentially be described in at least two high level manners, notification and tracking with regard to a medication schedule or regimen. As shown in FIG. 1, the system 100 can include a compliance management system 102 that is capable of monitoring and capturing events related to ingestion of medication. Generally, as illustrated, the compliance management system 102 can include a monitoring component 104 and a capture component 106 that together produce information that can be compared to a prescribed regimen thereby determining (and tracking) compliance.

In operation, the monitoring component 104 can be used to track user activity and events. The capture component 106 can log or otherwise maintain (or communicate) this information for evaluation or historical records. Features, functions and benefits of these components (104, 106) as well as associated sub-components are described infra.

The notification functionality is at least two fold. First, the compliance management component 102 can notify or alert a patient or individual of a time to take a dose of medication. Secondly, the compliance management component 102 can convey or otherwise notify healthcare entity, patient or individual of information related to compliance with a regimen or schedule. For instance, a record can be generated or updated upon each event related to ingestion of a medication. Similarly, a record can be generated each time a scheduled dose is missed. These records can be stored or otherwise transmitted (e.g., either wired or wirelessly) to a health record consolidation location, a healthcare entity or other third party. In operation, this information can be reviewed for medication effectiveness, patient progress, or the like.

The tracking portion of the functionality of system 102 can be related to record generation. These records can be used for a variety of purposes, including but not limited to, compliance determination, medication effectiveness assessment, patient progress, etc. For example, a record or log can be established and updated upon each event of ingesting medication. Here, the compliance management component 102 can calculate the amount of medication taken (e.g., number of pills, amount of liquid). This calculation can be facilitated by way of a sensing subsystem, for example, a weight sensing subsystem as described below.

The amount (or dosage) information can be generated using a counting subsystem, in the case of pills or tablets. As will be understood, the weight of amount of pills taken can be divided by the per pill weight thereby arriving with a tablet or pill count. This information can be stored in a record or log together with patient identification information, medication information, and temporal information (time of day, day of week). In other aspects, additional sensing means can be employed to capture physiological information. As will be appreciated, this physiological information can be used to assess patient progress, medicine effectiveness, among other uses.

As described above, patients sometimes forget to take, or alternatively, if they took their medicine on time. For instance a prescription may require the patient to take 2 tablets, 3 times a day. Suppose the patient was to take two tablets at 9:00 am. Next suppose it is 10:00 am and the patient is unable to recall whether he took the prescribed dose of the medication or not at 9:00 am. The innovation can provide an automated method for the patient to determine if they missed the 9:00 am dose or not. More particularly, the record can be displayed, for example on the bottle itself. Alternatively, the record can be accessed by way of an electronic device, e.g., personal computer, cell phone, smartphone, personal digital assistant, etc. As well, the innovation can alert or remind a patient to take the dose thereby alleviating possible missed doses.

Patients, doctors and pharmaceutical manufacturers currently have no effective way to easily track compliance to a particular prescription or regimen. The patient may have missed doses at some times or taken extra pills at other times inadvertently, such as forgetting a pill when travelling, losing motivation to follow through with a medication when effect is not immediate, being confused among multiple simultaneous medications, by making an innocent mistake or when suffering from partial dementia. Currently, there is no easy way for either the patient or the doctor to know how accurate the compliance was so that the doctor can correctly evaluate the effect of the treatment plan or so that the patient can manage his or her treatment in a more effective and safe manner.

With regard to alerts and reminders, conventional providers have attempted to employ services for patients related to their medication. For instance, a service provider may be able to call a patient to remind them to take their medicine. Unfortunately, these services are driven by manual operation and are therefore prone to be plagued by human error, mistake or the like. Additionally, even if a reminder is conveyed by these traditional services, there is no easy way to know if the patient actually takes the medicine or otherwise missed a dose.

In other aspects, patients may be using several over-the-counter drugs for which prescription information is not currently stored in any patient record. The patient may have taken these drugs in response to symptoms and, other than personal memory, has no easy way of knowing when and how much of the over-the-counter drug was taken, when it was taken, what effect it had, etc. This information may be relevant to know for the patient for several reasons such as to avoid overdose, see if a particular brand is more effective, to convey their medication history to a doctor or other healthcare professional, etc.

Unlike prescription medication, the time to order refills is most often not fixed for over-the-counter drugs. Certain service providers may be willing to send reminders about re-ordering over-the-counter drugs when the supply runs low. However these service providers do not currently have an easy way to know when a patient's drug supply is low. In contrast, the compliance management system 102 of the innovation can track supply by way of the monitoring component 104 (e.g., via sensing subsystems) thereby triggering an alert or notification when supply is low.

In one aspect, the compliance management system 102 can be incorporated into a medicine bottle (or lid) that automatically tracks how many tablets a patient took during a dosage event. Other aspects can be used in connection with liquid medicines, bubble wrap containers, creams, etc. to monitor, track and record dosage events. In operation, this information can be used to display notification of the last dosage on the bottle itself, provide a reminder (e.g., an audible, visual or vibratory alert) from the bottle, or to send a message (encrypted, if needed to preserve privacy) over a communication link or channel (e.g., email, instant message (IM), short message service (SMS), FM transmission, . . . ) to a supporting system that can remind a patient or individual of a dosage event. As described herein, the information generated by the innovation can also be used to generate compliance reports for the patients thereby facilitating effective and safe treatment management. Still further, in aspects, the captured event information can also be used to remind the patient to order refills as appropriate.

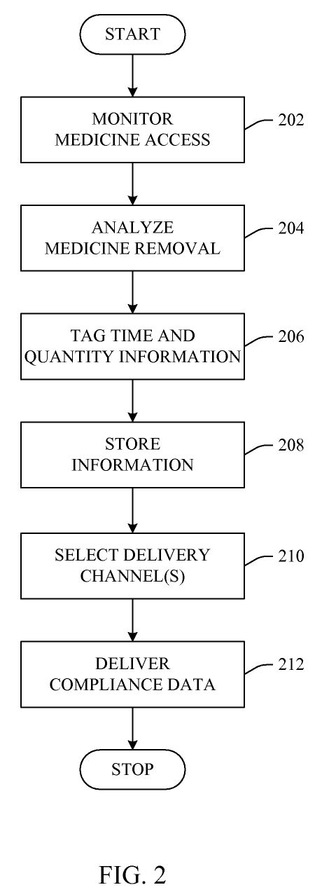

FIG. 2 illustrates a methodology of tracking medicinal dosage events in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, access to medicine is monitored. For example, the events related to accessing pills in a medicine bottle, liquid in a medicine bottle, pills in a bubble strip, cream in a tube or the like can be monitored. It is to be understood that detection of an access can trigger subsequent recordation and analysis of a dosage event.

Medicine removed from a container (e.g., bottle) can be analyzed to determine the quantity of medicine removed. In examples, the weight of pills or tablets can be used to calculate the quantity of pills based upon a per unit weight. For instance, in an example, a weight sensing subsystem can be incorporated into a pill bottle lid thereby enabling a user to effectively track the amount of medicine removed from the container. Other aspects can employ suitable mechanisms to measure amounts of liquid or other substances removed from a container such as a bottle, jar, bubble wrap sheet/strip or the like.

The event analyzed at 204 can be tagged with temporal information together with the quantity information at 206. Additionally, physiological information such as patient temperature, blood pressure, heart rate, etc. can be tagged to the event. It will be appreciated that this information can be useful in effectively managing and assessing patient conditions and progress.

The information is stored at 208, for example, the information can be stored in a local store, remote store, cloud-based store or the like. It is to be understood an appreciated that, storage of the information at 208 need not include the act of storing for long term use. In other words, it is to be understood that storage of the information at 208 can merely include an act of maintaining the information for review by, or transmission or delivery to a healthcare professional for analysis or review.

Continuing with the aspect of FIG. 2, a delivery channel can be selected at 210. For example, a selection can be made to determine if a wired or wireless channel is to be used for delivery. Additionally, the modality for delivery, e.g., email, IM, SMS or other specialized product or application. At 212, the data can be delivered as selected or deemed appropriate. In operation, selection can be made based upon a preference, policy, rule or otherwise inferred on behalf of a user (e.g., via machine learning and reasoning (MLR)). Alternatively, although not illustrated, the information can be displayed locally (e.g., upon the medicine container) such that an individual can easily and accurately monitor dosage(s) amounts and times.

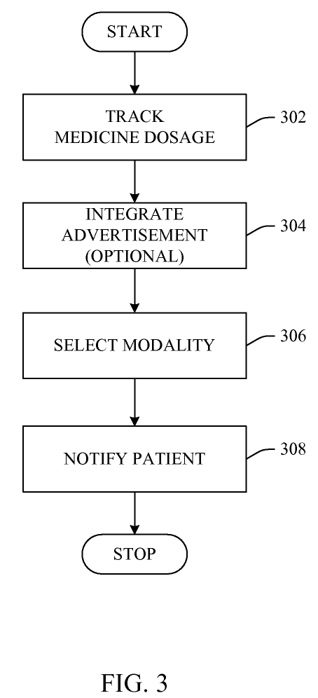

FIG. 3 illustrates an example methodology of notifying a patient of a scheduled dosage event in accordance with an aspect of the innovation. At 302, dosage information can be tracked, for example, trigger events can be logged into a calendar or appointment application. The dosage information can include when to take a dose of a medication as well as the quantity or amount to ingest. As will be understood, the information can be dynamic and therefore based upon prior dosage events in view of a prescribed or recommended schedule.

For example, if a medicine is to be taken every four hours, subsequent doses will be relative to the previous dose. In other words, if one dose is taken at 8:00 am, the next dose will be due to be taken at 12:00 pm. However, if the 12:00 pm dose is not taken until 12:15 pm, the next subsequent dose will be scheduled based upon the actual ingestion time. Thus, the subsequent dose will be scheduled for 4:15 pm rather than 4:00 pm as would have been the case if the schedule were based upon the initial dose.

Supplemental information such as advertisements can be integrated to enhance ability to target market. For example, advertisements related to a particular medication, condition, side effect, etc. can be incorporated into a message, alert or notification to be sent to an individual or patient. Here, advertisers can leverage the targeted audience to advertise products related to the subject of the medication or condition.

A modality for alert or notification can be selected at 306. For example, the modality selected can be an audible, visual or vibratory alert. Additionally, the message can be sent by way of most any protocol, e.g., wired or wireless. In other words, the system can be equipped with wireless technologies whereby alerts can be transmitted and received. Alternatively, the system can be wired, plugged, docked, etc. into an information system that delivers and/or receives schedule alerts. It will be understood that alert modalities can be based upon most any factor, including but not limited to, urgency, medication type, preference, policy, etc.

Once the modality and protocol are selected (e.g., based upon preference, policy . . . ) the patient or individual can be notified at 308. It is to be understood that other aspects can employ identity verification which can alleviate unwanted or unintentional disclosure of sensitive information. Additionally, with regard to recording events (e.g., FIG. 2), identity can be verified to confirm patient information thereby ensuring that the information is logged with reference to the correct patient or individual.

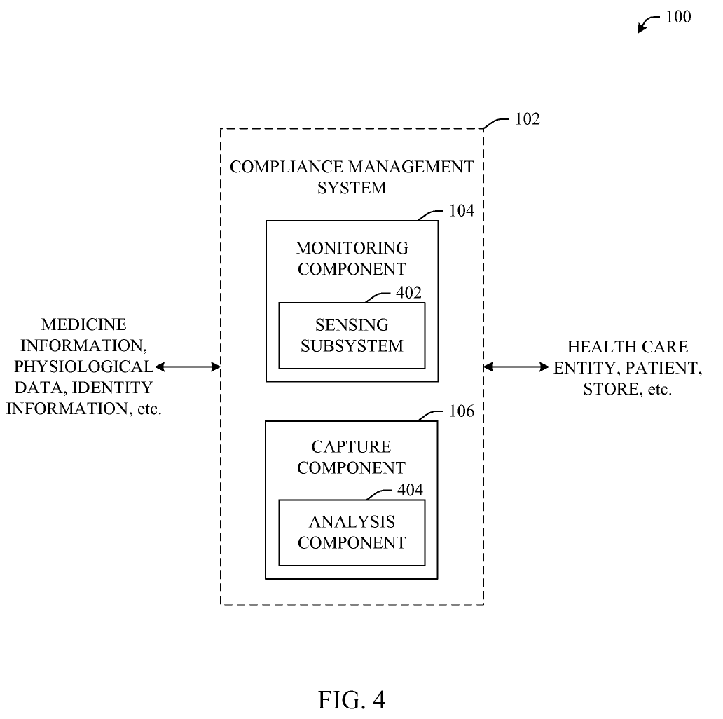

Turning now to FIG. 4, an alternative block diagram of system 100 is shown. As illustrated, subcomponents are illustrated integral to both the monitoring component 104 and the capture component 106. In this embodiment, a sensing subsystem 402 and an analysis component 404 are illustrated integral to the monitoring and capture components (104, 106) respectively.

As described with reference to FIG. 1, sensing systems (e.g., 402) can be incorporated into a medicine container, for instance, a lid of a medicine bottle. In one example, a screw-top lid can include a tablet pouring surface atop a sensing subsystem 402. In operation the sensing subsystem 402 can be employed to, for example, determine weight of dispensed tablets or pills.

An analysis component 404 can be employed to establish a number of pills associated with the weight. The analysis component 404 can employ a counting subsystem (incorporated therein) to divide the total weight by the per tablet or per pill weight, thereby arriving with the number of dispensed units.

In other examples, the subcomponents or subsystems can be incorporated into a base or docking type structure that calculates the dispensed medicine in a reverse-type fashion. In other words, rather than considering the dispensed medicine, the unit can consider the weight of the remaining medicine in relation to the weight prior to dispensing medicine. As described above, a per unit weight can be used to determine how many units are dispensed in an event.

In either scenario, the sensing subsystem can also be used to capture temporal and/or physiological information related to the dispensing event. This information can be incorporated into the captured record information thereby enhancing usefulness of the information for evaluation of a patient, drug, condition, progress, or the like.

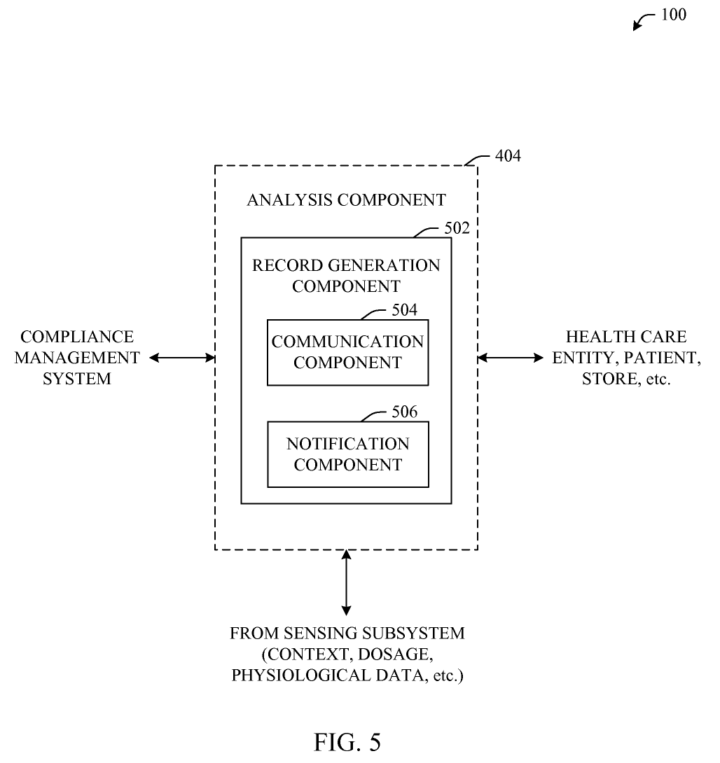

FIG. 5 illustrates an example block diagram of an analysis component 404 in accordance with an aspect of the innovation. In addition to the calculation logic described above, the analysis component 404 can include a record generation component 502 that aggregates, consolidates, configures and formats the information (e.g., dosage event information, temporal information, patient information . . . ) for storage and/or communication.

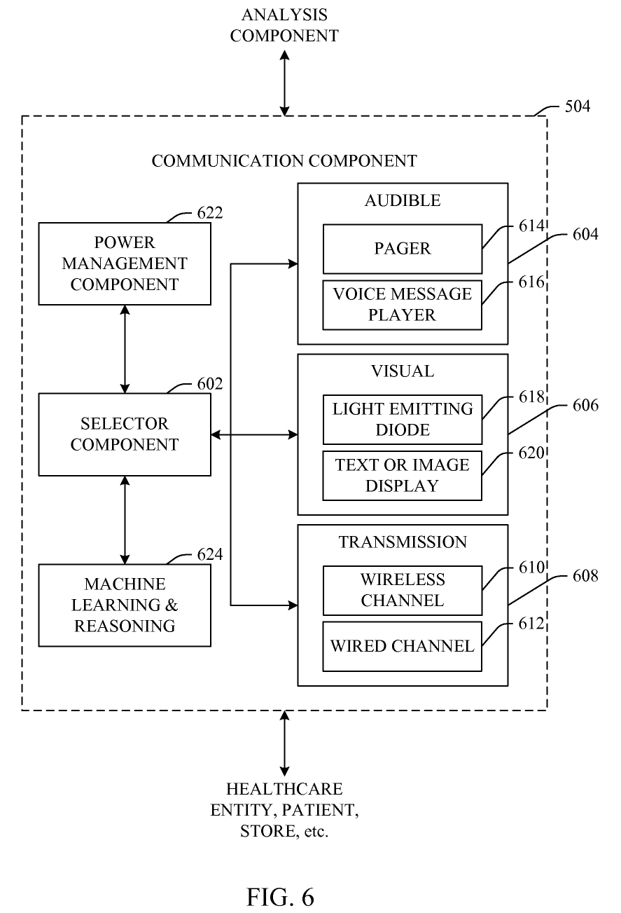

A communication component 504 can be employed integral (or separate from) the record generation component 502 to manage transmission of information, for example, to a healthcare entity, patient, store, local display, etc. As will be described with reference to FIG. 6, the communication component can be employed to establish protocols and modalities for delivery of information, notifications and alerts.

The notification component 506 can be employed to deliver the information or alert to an entity or individual as appropriate or desired. For instance, the notification component 506 can be employed to deliver captured information to a healthcare entity or alternatively, to a store for logging or subsequent evaluation.

Referring now to FIG. 6, a block diagram of an example communication component 504 is illustrated in accordance with aspects of the innovation. As described supra, the communication component 504 can be employed to manage transmission of information, notification and alerts to storage facilities, healthcare entities and individuals.

More particularly, communication component 504 can include a protocol and/or channel selector component 602. This selector component 602 can be employed to determine an appropriate protocol and/or channel by which to deliver information, alerts and notifications in accordance with the innovation. It is to be understood that the selector component 602 can be employed to convey an audible (604), visual (606), or vibratory (not shown) notification in alternative aspects. As well, the transmission component 608 can be employed to effect wireless or wired channel transmission (610, 612) as appropriate or desired.

With reference to audible transmission or alerting, the audible notification component 604 can include a pager 614 and/or a voice message player 616 in example embodiments. In operation, the pager 614 can be employed to deliver audible tones and alerts (e.g., beeper). The voice message player 616 can be utilized to deliver spoken or computer-generated speech to convey information or alerts related to trigger events.

Similarly, with reference to visual transmission or alerting, the visual notification component 606 can employ, for example, light emitting diodes 618 or text/image displays 620 to convey information or alerts. In operation, the visual notification component 606 can employ visual cues to convey information to an individual or healthcare entity.

As illustrated, the communication component 504 (or system 100 generally) can include a power management component 622. In aspects, the power management component 622 can enable systems and methods to reduce power, for example, to prolong battery life. In one aspect, to ensure accurate information, it is important that the energy supply of the medicine bottle last the life of the bottle or throughout the contents of the bottle. By way of example, the battery embedded in the bottle may be able to last easily for short duration prescriptions such as a week or so but, for long term prescriptions and over-the-counter drugs that are used for longer durations, it becomes essential to provide power to the medicine bottle for the various functions described above.

Accordingly, the innovation is capable of managing energy to reduce usage, harvest energy as well as to employ inductive coupling to reduce energy consumption and to make energy available to effect the functionality described herein. Following are example mechanisms by which power can be managed and harvested. It is to be understood that alternative aspects of power management exist—these alternative aspects are to be included within the scope of the innovation and/or claims appended hereto.

In aspects, the power management component 622 can be employed to reduce battery energy usage. In this example, the system can remain in a low power idle or sleep mode until an interesting event happens, for example a dispensing event. In this mode, it can be possible to power a low power consumption sensor such as the weight sensor while keeping most all other components shut down or in a hibernation state. By way of example, the event may be the user picking up the bottle and pouring medication, hence changing the input to the weight sensor. Another event may be a timer expiration generated by the system's clock or timing module.

When the system is activated, it can quickly generate the relevant records and send them out to the appropriate channels (as deemed by the selector component 601). Thereafter, the system can again enter a sleep mode to maintain low energy consumption.

In other embodiments, the system can harvest energy from alternative power sources. For example, the medicine bottle or device may be equipped with a solar cell that provides extra energy to the bottle's energy store. Another example can employ a kinetic energy producing source which generates energy merely by motion of the bottle, for example, in a user's pocket, briefcase or purse.

Inductive coupling can be used in yet another example to generate power. In this aspect, the bottle or device may have an inductive coupling mechanism to recharge or maintain power. Here, a user may be directed to store the medicine bottle on a table, shelf, or medicine cabinet that is equipped to supply power over an inductive coupling system. In this arrangement, the bottle (or device) can recharge its battery while stored. While specific examples are described, it is to be understood that alternative charging means can be employed in still other aspects—all of which are to be considered within the scope of this disclosure and claims appended hereto.

Further, FIG. 6 illustrates a machine learning & reasoning (MLR) component 624 which facilitates automating one or more features in accordance with the subject innovation. The subject innovation (e.g., in connection with channel selection, mode selection) can employ various MLR-based schemes for carrying out various aspects thereof. For example, a process for determining how best to transmit an alert or notification to a patient based upon most any factor, including but not limited to user's past reaction to alert mechanism (measured by whether the user responded by taking the medication after the alert), time, location, device availability, activity (e.g., context), can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria to whom, scope of content, when, where (e.g., device identity), and how (e.g., email, SMS, IM) to transfer information and/or alerts.

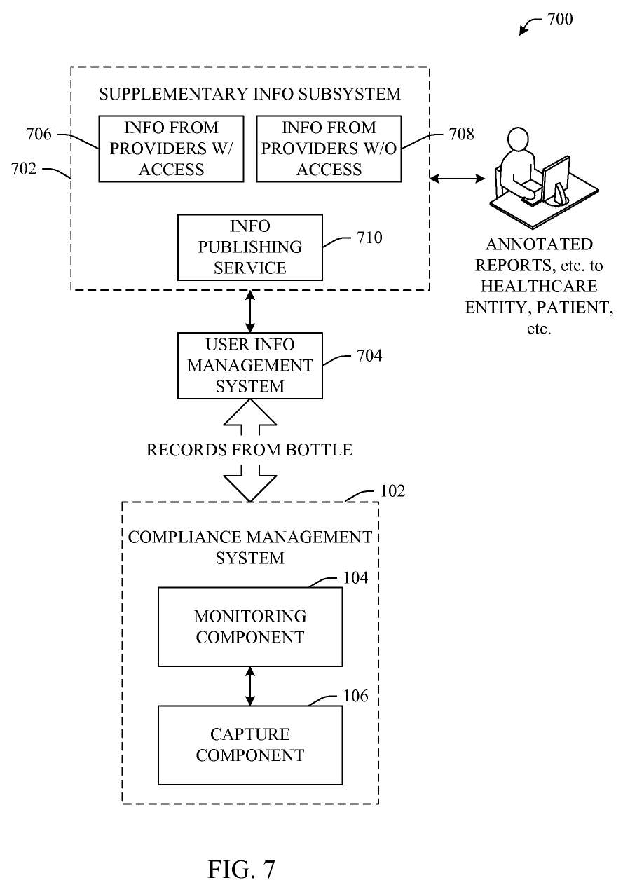

FIG. 7 illustrates yet another example block diagram of a system 700 that facilitates notification in accordance with an aspect of the innovation. As shown in FIG. 7, system 100 can include a supplementary information subsystem 702 and a user management system 704.

The records generated by the medicine bottle and the user information management system 704 (e.g., reminders, compliance reports, etc.) can be delivered to the user using several means and are likely to have user's attention when delivered. As shown, the user attention can be leveraged to provide supplementary information. In other words, the supplementary information subsystem 702 can be employed to annotate or otherwise include ancillary information as desired or appropriate into communications from the system. Such supplementary information could include educational information, warning the user about side effects, information about foods or drinks to be avoided when on this medication, related medical conditions to be aware of, exercises or foods that help, infectious nature of the disease and means to contain the spread of the infection.

In one embodiment, such supplementary information may be selected according to the information provider's choice (e.g., advertisements) where the information provider (706, 708) helps reduce the cost of the medication or user information management system operation through advertisement publishing fees. In other words, advertisement revenue facilitated by way of an information publishing service 710 can be employed to offset medicine costs as well as to provide an additional revenue stream.

In other aspects, supplementary information can be selected according to user's interests that are relevant to the information provider (e.g., advertisements for related healthcare products). In these aspects, the information provider (706, 708) may need access to user's information. It is to be understood that users may opt out of this availability of information. Additionally, this information would only be shared as allowed by privacy laws and user preferences.

The user information management system 704 (e.g., either on the user's computer or at a service provider's server) can generate or configure the medicine-related information to be sent to the user. A portion of this information and additional user data (e.g., age, gender) is available to some of the information providers 706. These providers 706 may generate information related to the reports or the user to be sent along with the information from the user information management system 704. Other information providers 708 may also provide information to be sent to the user and ask that their information be added to particular types of user reports or reminders.

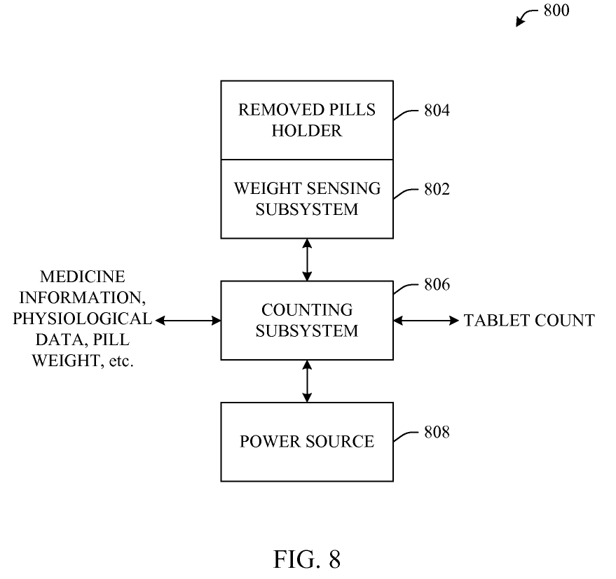

FIG. 8 illustrates an example block diagram of an alternative system 800 in accordance with aspects of the innovation. In these aspects, the system 800 can employ container a with sensing subsystem 802 to measure quantity of tablets, pills, liquid, or other form of medication taken by a user. By way of example, a patient can be instructed to pour tablets from a bottle into the lid (e.g., removed pills holder 804) prior to ingesting the tablets. As will be understood, this procedure is usually more hygienic than pouring tablets into the hand.

As described herein, the bottle lid can be capable to measuring weight. Alternatively, a subsystem (e.g., docking station or the like) can be employed to measure and/or calculate weight. A counting subsystem 806 can be employed to compare the weight compared against the standard tablet weight for the medicine contained in the bottle to determine the number of tablets.

As illustrated, the system 800 can include a weight measuring subsystem 802 attached to the container (e.g., removed pills holder) in which the pills removed from the bottle are placed. Typically, this is the bottle lid, but could be a separate container provided with the bottle, etc. The measured weight is passed on to the counting subsystem 806. The counting subsystem 806 obtains information about the medicine such as the weight of one pill and compares the weight. It is to be understood that this weight can be stored in the memory of the system, programmed into the firmware implementing the counting system 806, or provided using other suitable means.

Note that the measured weight may not be exact and the counting subsystem 806 divides the approximate weight by the pill weight to determine the approximate number of tablets. If the approximate number is close to an integer within a specified error margin, the tablet count is output. Otherwise, an error may be output or a repeated weight measurement may be obtained to retry the calculation. The power source 808 shown in the figure provides the energy to the system 800, and could be implemented using a battery, e.g., a button cell embedded in the lid), a solar cell on the bottle or lid surface, inductive coupling to a power source in the medicine cabinet, kinetic energy source, etc.

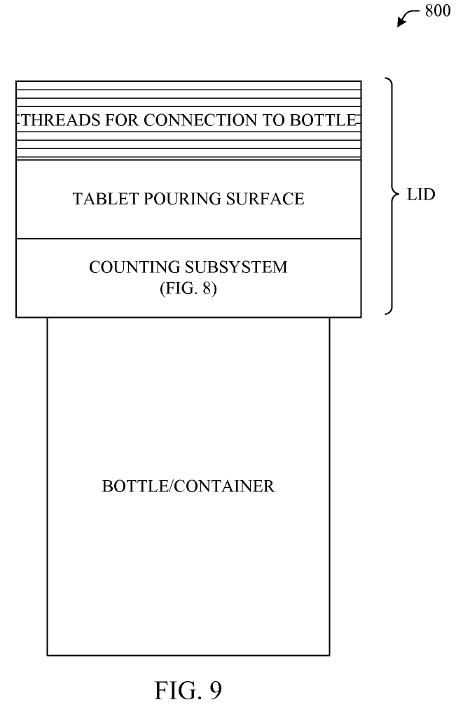

An example implementation of system 800 is illustrated in FIG. 9. This example implementation illustrates possible inclusion of the counting system of FIG. 8 into a medicine bottle lid. While a specific implementation is illustrated in FIG. 9, it is to be understood that alternative aspects exist which are to be included within the scope of this disclosure and claims appended hereto.

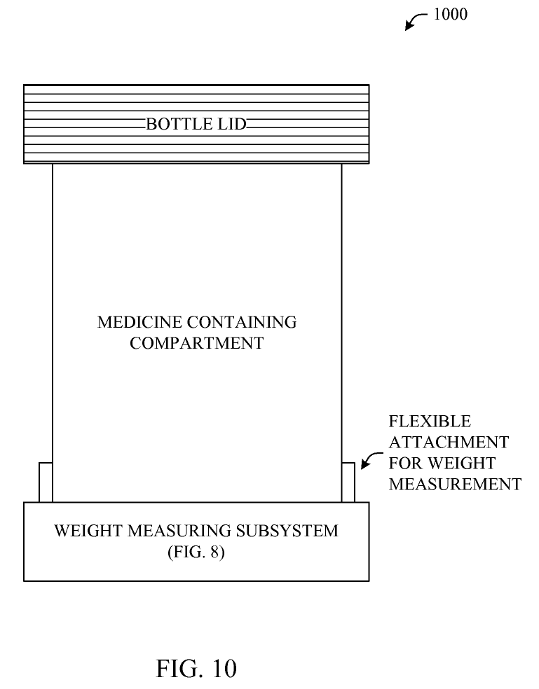

FIG. 10 illustrated yet another example aspect of the innovation. More particularly, a modified system 1000 is illustrated that enables measurement of liquids. A modification to the above design is possible where the medicine measuring system is not attached to the bottle lid or a separate container but, to the bottle itself. Also, instead of converting measured weight to tablet count, the weight can be converted to medicine volume, such as for liquid medications. The system 1000 is similar to that shown in FIG. 8 except that bottle weight before and after consumption is first used to determine the weight differential and the weight differential is converted to volume or count. Possible inclusion in a medicine bottle is shown in the system 1000 of FIG. 10. The flexible attachment could be implemented using a most any soft (or flexible) material that passes on the weight of the bottle to the weight measuring system, or a tubular attachment, etc. Additionally, it is to be understood that a docking-type subsystem can also be employed to measure dosage events of pills or tablets in other embodiments.

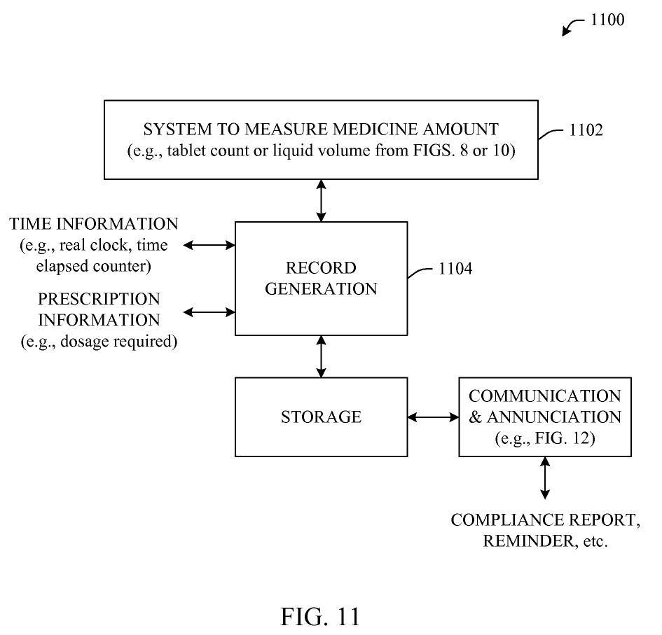

Turning now to FIG. 11, a system that communicates medicine consumption record is illustrated. An example block diagram of a system 1100 that determines compliance to the prescribed dosage and records the usage of the medicine is shown in FIG. 11. When the measurement system 1102 measures the amount of medication it can send that data to the record generation system 1104. The record generation component 1104 obtains the prescription information stored in the system memory or the program's firmware regarding dosage, etc. As illustrated, the record generation component 1104 can also obtain the time information, for example, either as a time of day or time elapsed since the prescription was started.

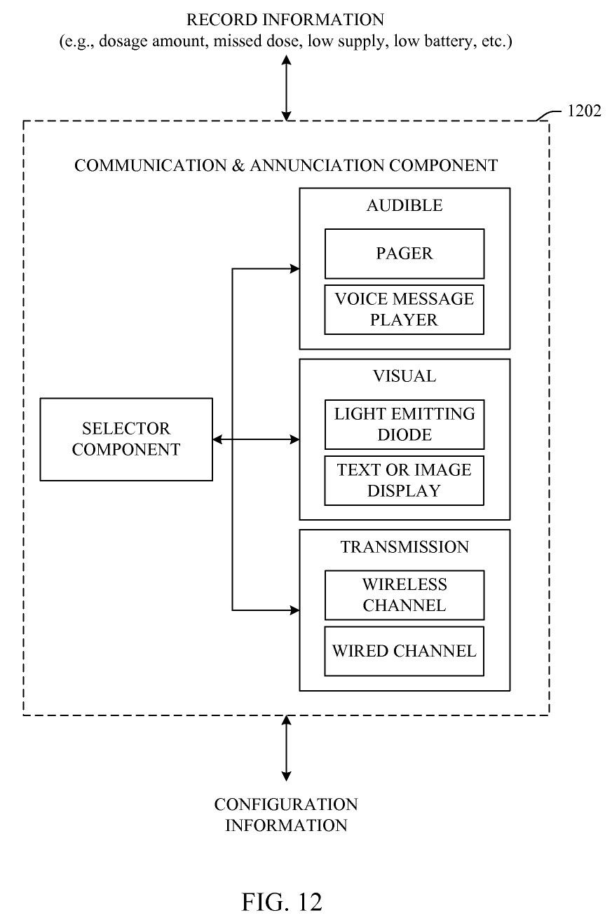

The dosage information is compared with the consumption information to generate a record regarding user's medication consumption. This record may be optionally stored in a local storage system for later retrieval by the user, healthcare providers or other legally authorized agencies. The record may be optionally sent to a communication and annunciation module (described in FIG. 12).

In another mode of usage, the record generation system 1104 may generate a record even when no information is received from the medicine amount measuring system. In this mode, the time information may initiate the generation of a record. The record generation system 1104 generates a record indicating no medicine was taken at the recorded (and scheduled) time and again may optionally store it locally or send to the communication and annunciation module. The record generation system may also generate other records such as low battery (e.g., when the power source is a battery), low supply in bottle (e.g., when the modified design that measures amount in bottle is used), etc.

Referring now to FIG. 12, an example communication and annunciation module 1202 is shown. As will be noticed, this illustration is similar to that of FIG. 6 shown and described supra, accordingly, much of the functionality is also similar to that described above. This module 1202 receives records from the record generation component (1104 of FIG. 11) and sends them over one or more available channels. The records may be used to generate audio signals, such as a beep or a voiced reminder when dosage is overdue. The records may be used to generate visual messages such as displaying the last dosage time on a display on the bottle lid, to blink an LED on the container when dosage is overdue, or other visual messages. The records may also be communicated over any available communication channel (e.g., Zigbee, 802.15.4, WiFi, 802.11, ISM band, connected to a home area network, a cell phone radio . . . ).

The communication channel may be connected directly or through intermediate communication systems such as, for example, access points, routers, gateways, to a user information management system (e.g., 704 of FIG. 7). A user information management system may exist on a computer, mobile phone or similar device in the user's home or assisted living facility, or at some service provider's server (e.g., Windows Live servers, health insurance company's server, pharmacy's server, etc.), for example, connected via the Internet.

The user information management system can receive the record and optionally adds it to the user's information database. It can also optionally generate a reminder if required (such as due to a missed dose) and deliver the reminder to the user by a phone call (playing a recorded message), an IM message, an SMS message to the user's phone, email, a service operator assisted message through a call center, or a similar message to the user's health professional such as a nurse. The user information management system may also generate further reports on user's medication schedule for compliance evaluation, insurance re-imbursements, drug abuse reporting etc.

As shown in FIG. 12, the communication and annunciation component 1202 can be used to communicate configuration information. More particularly, the communication and annunciation module 1202 may be used to communicate bottle configuration related information also, such as low battery, broken sensor, or other system operational information. The communication channel may also be configured in a two-way (or bi-directional) manner in which case the bottle can receive information. For instance, the user's prescription information may change and be downloaded to the bottle over the communication link. Time of day, clock settings, tablet weight, liquid medication volume weight relationship, and other such information may also be provided to the system over the communication link.

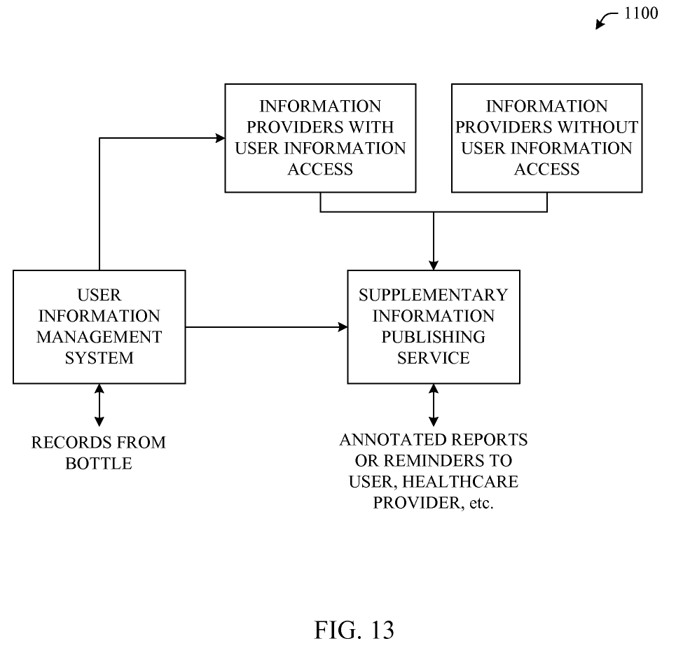

FIG. 13 illustrates a system 1300 that enables incorporation of supplementary information. As shown, records generated by the medicine bottle and the user information management system (e.g., reminders, compliance reports, etc.) can be delivered to the user using several means. As described above, the user's attention can be leveraged to provide supplementary information.

Such supplementary information may be selected in a variety of manners, including, but not limited to, according to the information provider's choice (e.g., advertisements) where the information provider helps reduce the cost of the medication or user information management system operation through advertisement publishing fees, or according to user's interests that are relevant to the information provider (e.g., advertisements for related healthcare products). In the second scenario, the information provider may access to user's information. It is to be understood that a user may opt out to allowing access to their information. Additionally, this information would only be shared as allowed by privacy laws and user preferences.

A block diagram of a system 1300 to add supplementary information is shown in FIG. 13. The user information management system (e.g., on the user's computer or at a service provider's server) generates the medicine related information to be sent to the user. A portion of this information and additional user data (e.g., age, gender) can be available to some of the information providers, for example, those labeled information providers with user information access in FIG. 13. These providers may generate information related to the reports or the user to be sent along with the information from the user information management system.

Other information providers (e.g., denoted information providers without user information in FIG. 13) may also provide information to be sent to the user and ask that their information be added to particular types of user reports or reminders. The arbitration component, shown as supplementary information publishing service, can accept the information from both types of providers and determines which information will be added to the user reports. The arbitration component may use information such as fees paid by the provider and user preferences in determining the selection of supplementary information.

The arbitration component may use advertisement auctioning mechanisms or other advertisement selection methods used in online advertisements to make determinations. The final report (e.g., an SMS with additional text, a medication reminder phone call with added special offers for advertised products) can be delivered to the user over their preferred communication channel.

As described above, it can be important to determine the identity of the person using the bottle or ingesting the medication. In many situations a single medicine bottle may be used by multiple people. For example, this happens often for over-the-counter drugs. Oftentimes, it then becomes hard to associate the consumption record with a specific user. If the dosage amount is different for two users sharing a bottle, the consumption amount may be used to associate the correct user. However, this is often not the case. The innovation employs at least the following two methods to determine the correct user for each association. While specific identity determination systems are described herein, it is to be understood that most any identity determination systems can be incorporated into the innovation's features, functions and benefits. Thus, these alternatives are to be included within the scope of this disclosure and claims appended hereto.

Referring first to a biometric identification (ID) system, in this system, a biometric ID device, such as a fingerprint scanner can be added to the medicine bottle along with a lid locking mechanism that is activated by the biometric ID device. Here, when a user wishes to access the medicine, they first activate the biometric ID device, such as by scanning their finger. Upon receiving a valid scan, this action unlocks the lid and also informs the system which user is accessing the medicine. It will be appreciated that this mechanism is also useful to prevent children or mentally ill patients from accidentally taking wrong drugs. This mechanism is also useful for patients who find the other child proof lids such as those that require pressing the lid while turning, annoying or cumbersome to use.

Another example employs a user selection interface. In this approach, a user interface is added to the bottle or its lid. This interface may present two or more switches to be moved, a keypad to enter a code or a similar mechanism to identify the user. When a user desires to access the medicine they activate their identity on the user interface. The interface may be further designed to lock the lid when no identity is entered, to prevent users from accidentally taking medication without identifying themselves

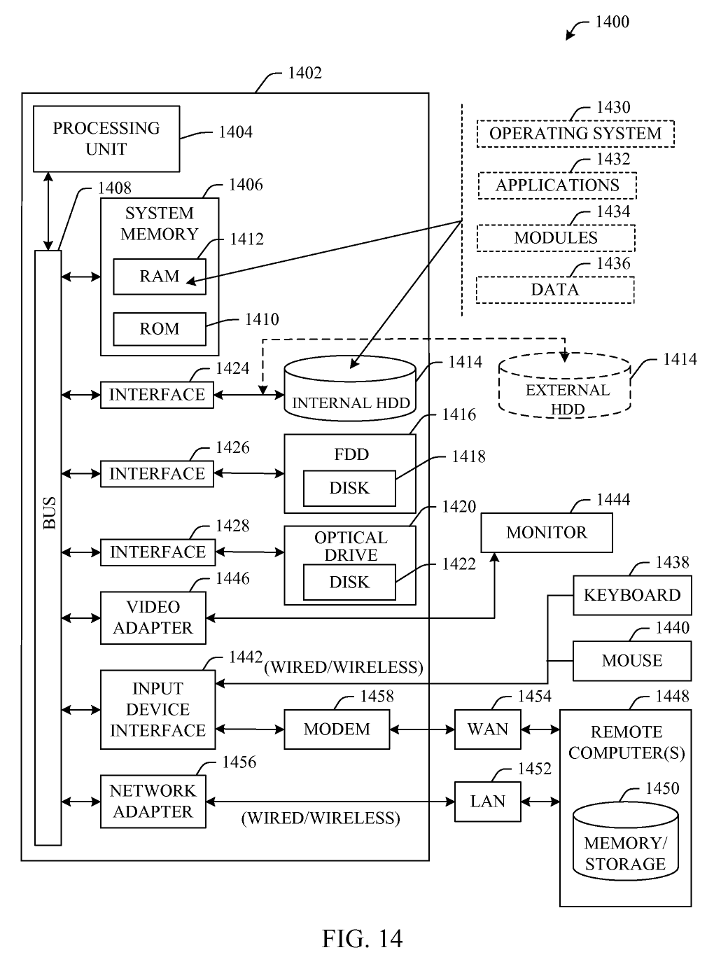

Referring now to FIG. 14, there is illustrated a block diagram of a computer operable to execute the disclosed architecture. In order to provide additional context for various aspects of the subject innovation, FIG. 14 and the following discussion are intended to provide a brief, general description of a suitable computing environment 1400 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, the exemplary environment 1400 for implementing various aspects of the innovation includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

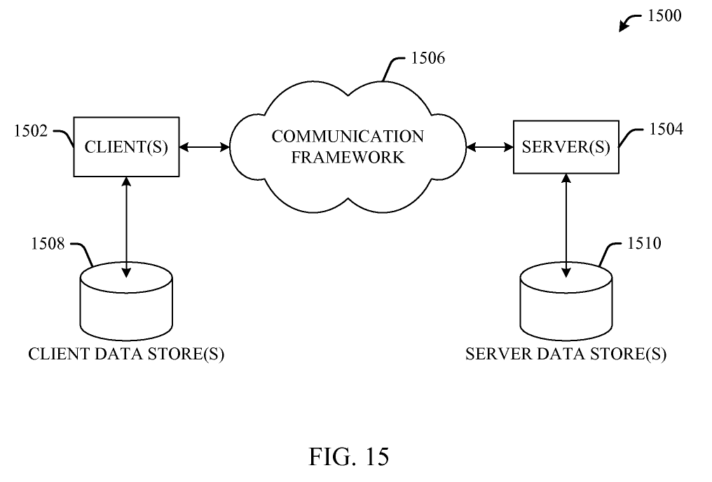

Referring now to FIG. 15, there is illustrated a schematic block diagram of an exemplary computing environment 1500 in accordance with the subject innovation. The system 1500 includes one or more client(s) 1502. The client(s) 1502 can be hardware and/or software (e.g., threads, processes, computing devices). The client(s) 1502 can house cookie(s) and/or associated contextual information by employing the innovation, for example.

The system 1500 also includes one or more server(s) 1504. The server(s) 1504 can also be hardware and/or software (e.g., threads, processes, computing devices). The servers 1504 can house threads to perform transformations by employing the innovation, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system to facilitate tracking of compliance to a medicinal regimen, comprising:
a container of medication;
a monitoring component configured to dynamically observe medication removal from the container in view of the medicinal regimen;
a capture component configured to record context information related to the removal;
a channel selector component configured to select a channel for communication, based upon at least one of a policy, rule or inference via machine learning and reasoning, wherein the channel is at least one of a wired or a wireless channel;
a communication and annunciation component configured to bi-directionally communicate, via a selected channel, information including prescription information, and container power supply and sensor status;
an identification component configured to control access to the container, when the container is locked, with at least one of a biometric mechanism or an interface mechanism;
wherein the monitoring component, the capture component, the channel selector component, the communication and annunciation component and the identification component are incorporated into the container; and
a supplementary information component configured to, via the selected channel, communicate an advertisement, wherein the advertisement is associated with a reduction in cost of the medication, and to determine, based on at least a preference, a provider fee, and advertisement auctioning or other advertisement selection method, supplementary information to be added to a medication-related report.

2. The system of claim 0, wherein the container is a pill bottle.

3. The system of claim 0, wherein the medication is in pill form.

4. The system of claim 0, wherein the medication is in liquid form.

5. The system of claim 0, further comprising a sensing subsystem component configured to employ a plurality of sensors to capture at least one of time of day, day of week, weight of medication removed, amount of medication removed, or a physiologic criterion.

6. The system of claim 1, further comprising an analysis component configured to evaluate the context information and generate record information related to the removal of medication.

7. The system of claim 6, further comprising a communication component configured to employ a selected channel to convey the record information to at least one of a healthcare entity or store.

8. The system of claim 7, wherein the channel includes at least one of an email, instant message (IM), short message service (SMS), or FM transmission channel.

9. The system of claim 1, further comprising a notification component configured to employ at least one of audible, visual or vibratory alerting notification.

10. The system of claim 1, wherein the supplementary information component is further configured to annotate the context information with disparate information from at least one of a source with access to patient information, or a source without access to patient information.

11. The system of claim 1, further comprising a power management component configured to control power via use of at least one of a sleep mode or a solar cell.

12. The system of claim 0, further comprising a machine learning and reasoning (MLR) component configured to employ at least one of a probabilistic and a statistical-based analysis to infer an action to be automatically performed.

13. A computer-implemented method of tracking compliance with a medicine treatment, comprising using a processor coupled to a memory to perform the following operations:
monitoring access to an amount of medication in a container;
calculating dosage of the amount of the medication;
recording the dosage and temporal information associated with the access,
selecting a channel for communication, based upon at least one of a policy, rule or inference via machine learning and reasoning;
bi-directionally communicating, via the selected channel, information including prescription information, and container power supply and sensor status;
controlling access to the container, when the container is locked, with at least one of a biometric mechanism or an interface mechanism;
communicating an advertisement associated with a reduction in cost of the medication via the selected channel; and
determining, based on at least a preference, a provider fee, and advertisement auctioning or other advertisement selection method, supplementary information to be added to a medication-related report.

14. The computer-implemented method of claim 13, further comprising conveying the recorded information to a healthcare entity via a wired or wireless channel.

15. The computer-implemented method of claim 13, further performing a notification of a dosage time to prompt the access to the amount of medication.

16. The computer-implemented method of claim 15, further comprising integrating supplemental information including at least one of an advertisement or a product offer into the notification.

17. The computer-implemented method of claim 13, further comprising optimizing power management utilizing at least one a sleep mode or a standby mode.

18. The computer-implemented method of claim 13, further comprising:
verifying an identity to to regulate the access; and
recording the identity associated with the access.

19. A computer-readable storage medium storing instructions, the instructions to, if executed by a computing device, cause the computing device to perform operations for tracking compliance with a dosage schedule, the operations comprising:
monitoring access to a medication in a container;
calculating an amount of the medication related to the access;
establishing temporal information related to the access;
accessing supplemental information based at least in part upon the medication;
tagging the amount with the temporal and supplemental information;
selecting a channel for communication, based upon at least one of a policy, rule or inference via machine learning and reasoning;
conveying, via the selected channel, the tagged and supplemental information to a healthcare entity in the form of an annotated report;
bi-directionally communicating, via the selected channel, information including prescription information, and container power supply and sensor status;
controlling access to the container, when the container is locked, with at least one of a biometric mechanism or an interface mechanism;
communicating an advertisement associated with a reduction in cost of the medication via the selected channel; and
determining, based on at least a preference, a provider fee, and advertisement auctioning or other advertisement selection method, supplementary information to be added to the annotated report.

20. The computer-readable storage medium of claim 19, the operations further comprising establishing an identity to regulate access to the medicine.
